(19) United States
(12) Patent Application Publication
(10) Pub. No.: US 2008/0035017 A1
(43) Pub. Date: Feb. 14, 2008

(54) Room temperature process for preparation of pearl pigments by precipitation method

(75) Inventor: Eun Young Chung, Gyeonggi-do (KR)

Correspondence Address: EDWARDS ANGELL PALMER & DODGE LLP, P.O. BOX 55874, BOSTON, MA, 02205, US

(73) Assignee: Hyundai Motor Company, Seoul (KR)

(21) Appl. No.: 11/637,294

(22) Filed: Dec. 11, 2006

(30) Foreign Application Priority Data
Aug. 11, 2006 (KR) 10-2006-0076056

(51) Int. Cl. C09D 11/00; C09C 1/00; B05D 3/02; C04B 14/20; C09C 1/14; C04B 14/00; C09C 1/36; C04B 14/04

(52) U.S. Cl. 106/31.6; 106/31.9; 106/415; 106/417; 106/436; 106/432; 106/416; 106/479; 106/482; 427/376.1

(57) ABSTRACT

The present invention relates to a process for preparing a pearl pigment, comprising the steps of (a) adding an aqueous solution of metal oxide to a substrate in a reactor and (b) adding ammonium bicarbonate aqueous solution as a precipitating agent.

### CROSS-REFERENCE TO RELATED APPLICATIONS

This application claims the benefit of Korean Patent Application No. 10-2006-0075056, filed Aug. 11, 2006, which is incorporated by reference herein in its entirety.

### BACKGROUND OF THE INVENTION

1. Field of Invention

The present invention relates to a process for preparing a pearl pigment based on low-refractive-index substrates having a high-refractive-index metal oxide coating. More particularly, it relates to a process for preparing a pearl pigment, comprising the steps of (a) adding an aqueous solution of metal oxide to a substrate in a reactor and (b) adding ammonium bicarbonate aqueous solution as a precipitating agent.

2. Background

Pearl pigments are employed in many areas of industry, in particular in the area of automotive finishes, decorative coatings, plastics, paints, printing inks and in cosmetic formulations.

The color of these pigments is caused by wavelength-selective partial reflection and interference of the reflected or transmitted light at the medium/oxide or oxide/substrate interfaces.

Owing to their color play, pearl pigments, which exhibit an angle-dependent color change between a plurality of interference colors, are of particular interest for automotive finishes.

Processes for preparing pearl pigments are commonly known in the prior art, for example, German Patent No. 2,214,545, U.S. Pat. No. 3,087,829 and Korean Patent No. 178,855, which disclose a method for coating metal oxide with high refractive index on mica. Conventionally, pearl pigments are produced by coating natural mica with a metal oxide such as titanium oxide to create the pearl-like effect.

However, such conventional processes have the following disadvantages: (1) heat treatment at an elevated temperature is required; (2) the time for reaction and cooling is substantially long (e.g., about 5 hours); (3) repeated processes such as precipitation, washing, drying and calcination are required; (4) due to the difficulty of pH control, agglomeration and non-uniform coating frequently occurs; and (5) a relatively large amount of precipitating agent is required.

Thus, there is a need for a more simplified and cost effective method for preparing pearl pigments.

The information disclosed in this Background of the Invention section is only for enhancement of understanding of the background of the invention and should not be taken as an acknowledgement or any form of suggestion that this information forms the prior art that is already known to a person skilled in the art.

### SUMMARY OF THE INVENTION

In one aspect, a process for preparing a pearl pigment is provided, comprising the steps of: (a) adding an aqueous solution of metal oxide to a substrate in a reactor; and (b) adding ammonium bicarbonate aqueous solution as a precipitating agent.

In another aspect, a process for preparing a pearl pigment is provided, comprising the steps of: (a) preparing a slurry by dissolving mica in distilled water in a reactor; (b) preparing a titanium aqueous solution; (c) preparing an ammonium bicarbonate aqueous solution as a precipitating agent; (d) adding the titanium aqueous solution and the ammonium bicarbonate aqueous solution into the slurry with stirring; and (e) separating a precipitate from the reactor.

In yet another aspect, a vehicle finishes, decorative coatings, plastics, paints, printing inks or cosmetic formulations comprising the pearl pigment produced by a described process are provided.

It is understood that the term “vehicle” or other similar term as used herein is inclusive of motor vehicles in general such as passenger automobiles, buses, trucks, various commercial vehicles, and the like.

Other aspects of the invention are discussed infra.

### BRIEF DESCRIPTION OF THE DRAWINGS

FIG. 1 is a SEM photograph of precursor coated on mica thin plate before calcination according to Example herein.

FIG. 2 is a XRD result of products after calcination according to Example herein.

FIG. 3 is a SEM photograph of the surface structure of titanium dioxide coated on mica thin plate after calcination according to Example herein.

FIG. 4 is a TEM photograph of the inner structure of titanium dioxide coated on mica thin plate according to Example herein.

FIG. 5 is a SEM photograph of the surface structure of titanium dioxide coated on mica thin plate after calcination according to Comparative Example.

FIG. 6 is a XRD result of the products after calcination according to Comparative Example.

### DETAILED DESCRIPTION

As discussed above, in one aspect, the present invention provides a process for a process for preparing a pearl pigment, comprising the steps of (a) adding an aqueous solution of metal oxide to a substrate in a reactor and (b) adding ammonium bicarbonate aqueous solution as a precipitating agent.

In a preferred embodiment, the metal oxide aqueous solution and the ammonium bicarbonate aqueous solution may be introduced into the reactor through two different inlets. Although there is no limitation on the position of the inlets in the reactor, the inlets may preferably be placed in the opposite sides of the reactor.

A preferred substrate to be used in the present invention includes, is not limited to, mica, a phyllosilicate, PbCO₃×Pb(OH)₂, BiOCl or platelet shaped SiO₂. A more preferred substrate is mica.

Metal oxide can be any of one that may be used for coating material, which are well known in the art. A suitable metal oxide, however, may be titanium oxide.

In another preferred embodiment, the titanium oxide aqueous solution can be prepared by using 9.6-28.8 w/v % of titanium salt relative to mica. The ammonium bicarbonate aqueous solution can be prepared by using 1.5-10 moles of the ammonium bicarbonate relative to 1 mole of the titanium salt.

In yet another preferred embodiment, when the titanium aqueous solution and the ammonium bicarbonate aqueous solution are introduced, the reactor may be agitated. A preferred agitation speed is 3000-6500 rpm.

In a further preferred embodiment, the process of the present invention may further comprise the step of calcining the substrate at 800° C. for 30 minutes.

In such preferred embodiments of the present invention, the reactor may be run at room temperature.

In another aspect, a process for preparing a pearl pigment is provided, comprising the steps of: (a) preparing a slurry by dissolving mica in distilled water in a reactor; (b) preparing a titanium aqueous solution; (c) preparing an ammonium bicarbonate aqueous solution as a precipitating agent; (d) adding the titanium aqueous solution and the ammonium bicarbonate aqueous solution into the slurry with stirring; and (e) separating a precipitate from the reactor.

Preferably, a precursor may be prepared at room temperature for coating titanium dioxide (TiO₂) on mica thin plate. Specifically, mica may be dissolved in distilled water in a reactor with stirring to provide a slurry.

Then, titanium aqueous solution may be prepared by using a titanium salt, suitably, TiOSO₄.

Preferably, the titanium aqueous solution may be prepared by using 9.6-28.8 w/v % of titanium salt relative to the mica. The content of below 9.6 w/w % may reduce the pearl gloss because of sparse surface of the titanium dioxide coated on mica. In contrast, the amount of above 28.8 w/w % is not preferable because it is more than needed to provide the pearl effect.

Suitably, the ammonium bicarbonate aqueous solution may be prepared by using 1.5-10 moles of the ammonium bicarbonate relative to 1 mole of the titanium salt.

When less than 1.5 moles of ammonium bicarbonate relative to 1 mole of titanium salt is used, sufficient nucleation may not be induced. By contrast, the use of more than 10 moles may induce excess nucleation and cause agglomeration of titanium salt on mica.

Suitably, the titanium aqueous solution and the ammonium bicarbonate aqueous solution may be introduced through two different inlets of the reactor. When they are introduced into the reactor through two different inlets, which are preferably equipped on the opposite positions of the reactor, undesirable nucleation of titanium salt can be prevented. Particularly, when a precipitating agent and a titanium salt are introduced simultaneously on mica thin plate, the salt and the precipitating agent can be nucleated shortly after they are introduced into the mica thin plate. As a result, titanium salt is less likely to be coated into mica thin plate, thereby causing non-uniform particle distribution.

A preferred process of the present invention may further comprise an agitation step. Particularly, when the titanium aqueous solution and the ammonium bicarbonate aqueous solution are introduced into the slurry, the reactor can be agitated at a speed of 3000-6500 rpm. In a preferred embodiment, the amount introduced may be controlled at 20 mL/min for 1 hour with stirring at 3,000-6,500 rpm by using, for example, micro tube pump. Agitation at a speed of below 3,000 rpm may cause agglomerization of particles. Agitation at a speed of above 6500 rpm may overheat the agitation system employed.

Another preferred process of the present invention may further comprise the steps of washing with distilled water, drying and calcining the precipitate. Preferably, the calcination can be performed at 800° C. for 30 minutes.

In yet another aspect, a vehicle finishes, decorative coatings, plastics, paints, printing inks or cosmetic formulations comprising the pearl pigment produced by a described process are provided.

As described above, the processes of the present invention can be conducted at room temperature. This is believed to be a result of employing ammonium bicarbonate as a precipitating agent.

Because superior pearl pigments require a substrate with low refractive index and a coating of metal oxide with high refractive index, the metal oxide particle coated on mica thin plate as a substrate is preferred to have uniform particle distribution and thickness. For this reason, conventional methods have used widely known precipitating agent, such as urea or ammonia.

Like such conventional precipitating agents, ammonium bicarbonate has a hydrolyzing activity, catalyzing the following reaction.

H₂O [symbol] H⁺+OH⁻

NH4HCO₃ [symbol] NH₄⁺+HCO₃⁻

HCO₃⁻ [symbol] H⁺+CO₃²⁻

H⁺+HCO₃⁻ [symbol] H₂CO₃

As shown below, however, nucleation of titanium dioxide (TiO₂) on mica thin plate is induced through the reaction of OH⁻ and carbonate with metal ion.

TiOSO₄+Mica [symbol] TiO₂−Mica+(NH₄)₂SO₄+H₂CO₃

The reaction suggests a possibility of nucleation at a low temperature because OH⁻ and carbonate tend to combine with metal for chemical stability, thereby causing metal ion to have low solubility.

Therefore, by using never-tried ammonium bicarbonate as a precipitating agent, the present invention enables the precursor to be synthesized for less than 1 hour without heat treatment via a relatively simple process.

In addition, the present invention makes up for the drawback associated with low-temperature synthesis by using a high-speed agitation system. As discussed above, because nucleation begins immediately after titanium salt and precipitating agent are introduced into mica thin plate, it is highly likely to obtain non-uniform particle size distribution due to the high agglomerizability of the particles. Thus, high-speed agitation system makes a contribution to induce precipitation effectively for a shortened period of time with minimized agglomerization.

Generally, pH condition is very important in performing precipitation on mica thin plate. Because metal salt (especially, titanium salt) has a low pH value, basic precipitating agent should be used to control pH value. Thus, a substantially large amount of urea or ammonia will be required in order to reach the pH range where nucleation begins, while a substantially less amount of ammonium bicarbonate is required to achieve the same result as urea or ammonia, thereby reducing production cost.

Further, it may be directly introduced without controlling the pH value, and the reaction terminates at pH 7 (neutral condition) without any need to use any other reagent except distilled water for washing process.

Nucleation and growth may not happen because products are washed with distilled water immediately after the reaction terminates, which removes impurities and also disperse a little agglomerized particles.

Compared to conventional filtering type, the present invention can use centrifuge and Vortex mixer as a separating tool, which is simple and effective.

As shown in Examples, after precursor of pearl pigments was prepared by coating titanium salt on mica thin plate, the present inventors ascertained that particles have close and small size distribution as a result of SEM analysis.

Further, thus-obtained precursor was subject to calcination at 800° C. for 30 minutes by elevating tempera at 5° C./min, followed by XRD, SEM and TEM analyses.

XRD result showed that the product has Anatase phase (crystalline titania) and mica phase, which indicates coating process was well performed without breaking Mica crystallite structure.

Generally, titania crystallite structure coated on mica thin plate becomes into Anatase phase as a result of calcination at 900° C. In the present invention, highly crystalline Anatase phase was obtained even at 800° C.

Further, SEM and TEM analyses showed that the process herein is appropriate for obtaining superior pearl pigments with uniform particle size and thickness (about 30 nm) although the synthesis is performed at room temperature. This has been ascertained from the result that chrominosity is 85.17 with spectrometry.

The following examples are presented to illustrate further various aspects of the present invention, but are not intended to limit the scope of the invention in any aspect. All documents mentioned herein are incorporated herein by reference.

### EXAMPLES

### Example

According to the present invention, pearl pigments were prepared at room temperature by using ammonium bicarbonate (NH₄HCO₃) as a precipitating agent.

First, as described below, the precursor was prepared at room temperature for manufacturing pearl pigments comprising mica thin plate coated with titanium dioxide (TiO₂).

In a reactor (2 L), 5 w/v % of mica was dissolved in distilled water with stirring to produce 200 mL slurry.

1 M of titanium aqueous solution was prepared by using TiOSO₄ as titanium salt. Ammonium bicarbonate aqueous solution was prepared by using 1.5-10 moles of ammonium bicarbonate relative to 1 mole of titanium salt as a precipitating agent.

Ammonium bicarbonate aqueous solution and titanium aqueous solution were introduced into mica slurry prepared at room temperature simultaneously. To prevent the nucleation of titanium salt only, they were introduced into the reactor through two different aqueous solution inlets, which had been equipped on the opposite positions of the reactor.

The amount introduced was controlled as 20 mL/min for 1 hour with stirring at 6,500 rpm by using micro tube pump.

Thus-produced precipitates were subject to the liquid-solid centrifugal separation immediately after the reaction terminates, followed by washing with a distilled water four times, and dispersion of agglomerated particles with a Vortex mixer.

The products were sufficiently dried at 100° C. for 5 hours, the precursors were pulverized and calcination at 800° C. for 30 minutes.

Thus-obtained products were characterized to be Anatase phase uniformly coated on mica thin plate. Measurement of color difference ascertained high luminosity and superiority as pearl pigments.

### Comparative Example

Precursors were prepared at room temperature by the same procedure as in Example. The reactants were synthesized with stirring at 1,500 rpm.

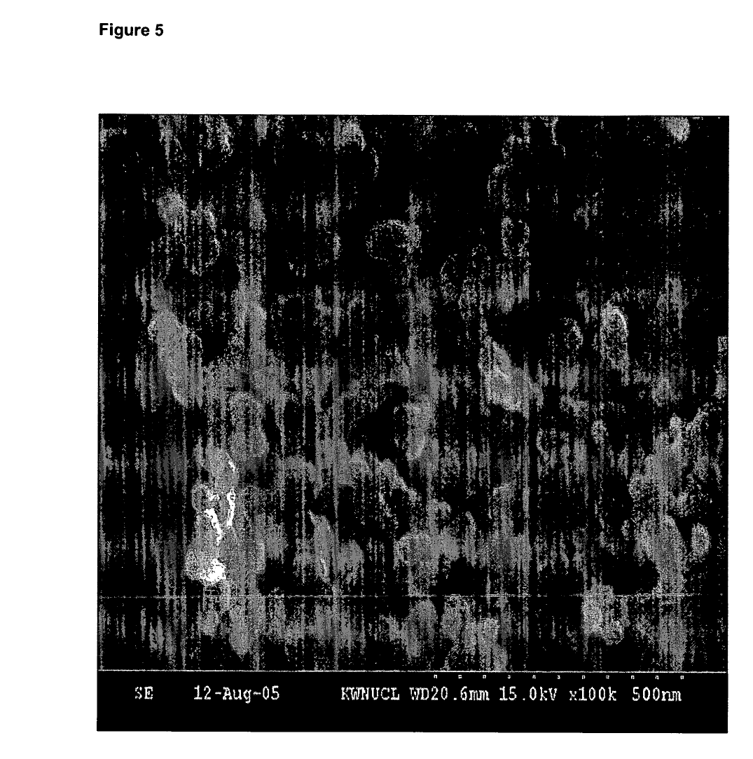

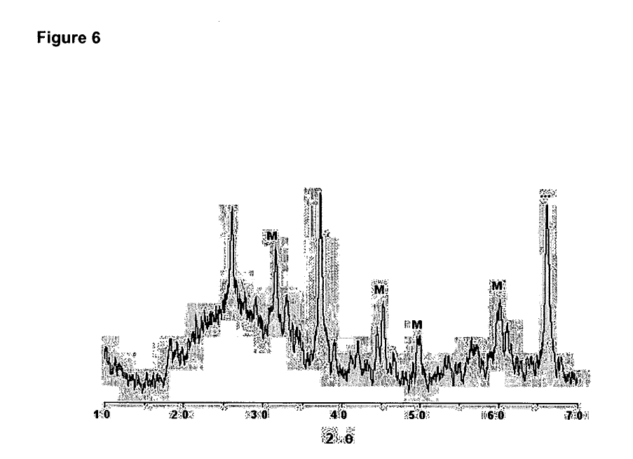

FIG. 5 is a SEM photograph of the surface structure of titanium dioxide coated on mica thin plate after calcination. FIG. 6 is a XRD result of the products after calcination.

Calcinated product has sparse particle distribution, and showed non-uniform agglomeric particle shapes. Anatase was not detected in XRD.

### Experimental Example

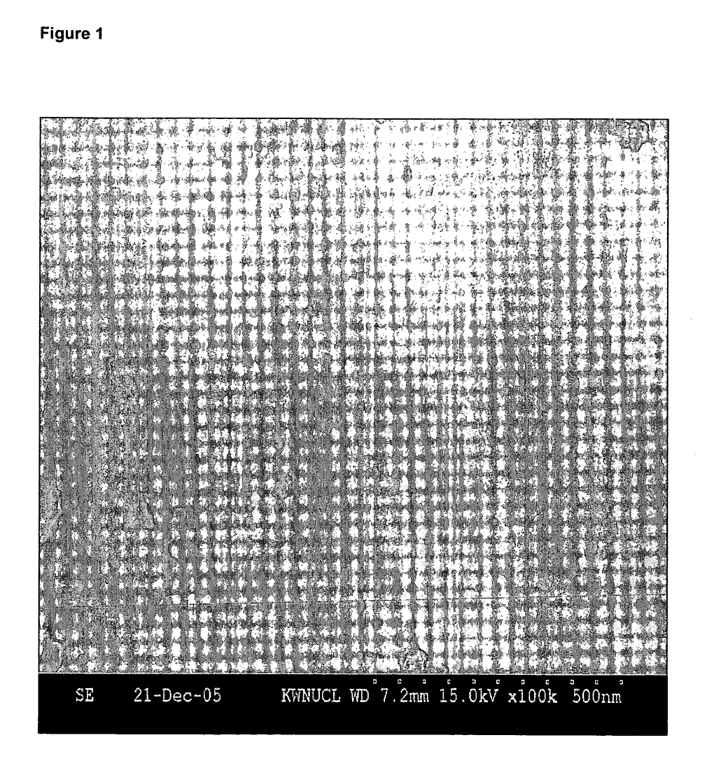

Precursors of titanium hydroxide coated on mica thin plate before calcination was observed by using Field Emission Scanning Electron Microscope (FESEM). The result is shown in FIG. 1.

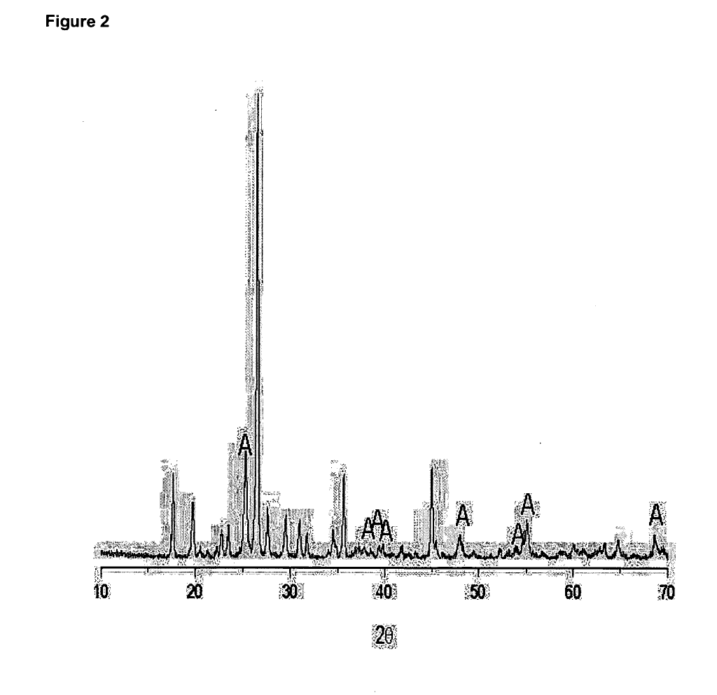

Further, products after calcination were analyzed by using X-Ray Diffractometry (XRD). The result is shown in FIG. 2.

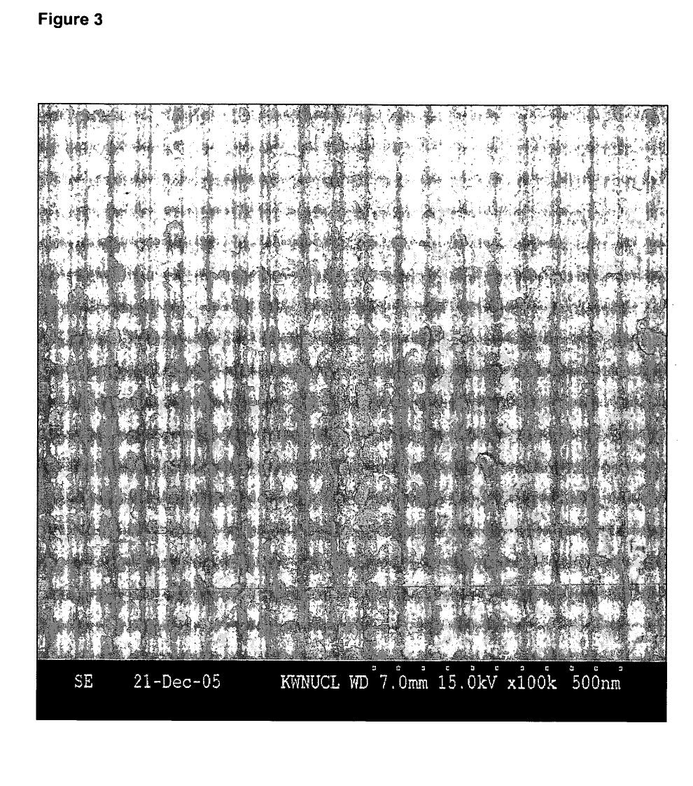

Furthermore, the surface structure of titanium dioxide coated on mica thin plate was observed by using FESEM, and uniform particle distribution was ascertained. The result is provided in FIG. 3.

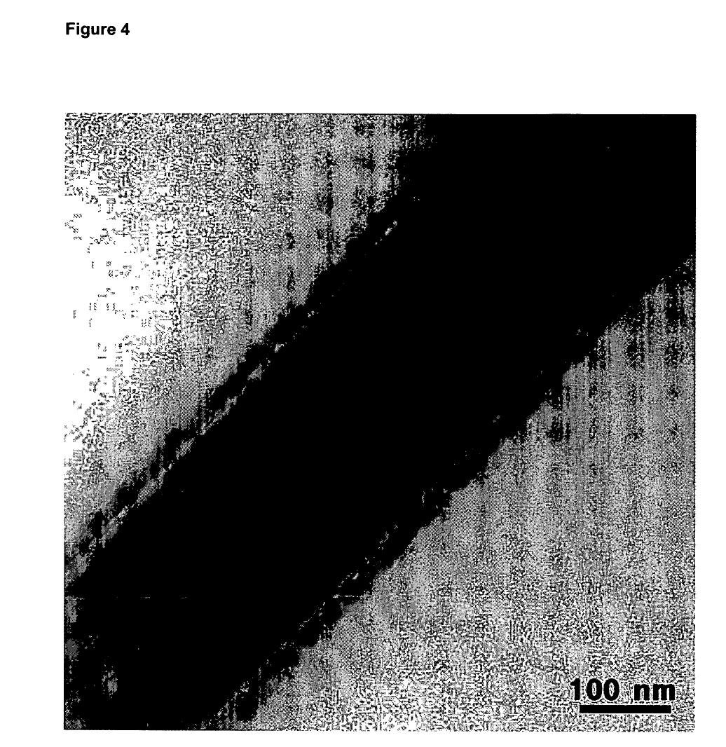

The inner structure of titanium dioxide coated on mica thin plate was observed by using TEM, and uniform coating was ascertained. The result is provided in FIG. 4.

Further, pearl pigments comprising mica thin plate coated with titanium dioxide (TiO₂) after calcination was subject to the measurement of color difference value, and high luminosity was ascertained. The result is provided in Table 1.

TABLE 1
Color coordinate

| Luminosity | Green-red saturation | Blue-yellow saturation |
|---|---|---|
| 85.17 | 3.18 | 15.02 |

As set forth above, in the present invention, titanium salt and ammonium bicarbonate aqueous solution as a precipitating agent are added on mica thin plate by using room-temperature hydrolysis, thus enabling to uniformly control particle size and thickness of coated layer and prepare pearl pigments having superior gloss and saturation.

Further, the present invention is also superior in economical aspect in that it may control the phase at room temperature for a relatively shorter reaction time as compared to the conventional method.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A process for preparing a pearl pigment, the process comprising the steps of:
(a) preparing a slurry by dissolving mica in distilled water in a reactor;
(b) preparing a titanium aqueous solution;
(c) preparing an ammonium bicarbonate aqueous solution as a precipitating agent;
(d) adding the titanium aqueous solution and the ammonium bicarbonate aqueous solution into the slurry with stirring, wherein the titanium aqueous solution and the ammonium bicarbonate aqueous solution are introduced through two different inlets of the reactor; and
(e) separating a precipitate from the reactor.

2. The process of claim 1, wherein the titanium aqueous solution is prepared by using 9.6-28.8 w/v % of titanium salt relative to the mica, and the ammonium bicarbonate aqueous solution is prepared by using 1.5-10 moles of the ammonium bicarbonate relative to 1 mole of the titanium salt.

3. (canceled)

4. The process of claim 1, wherein the titanium aqueous solution and the ammonium bicarbonate aqueous solution are introduced into the slurry with stirring at 3000-6500 rpm.

5. The process of claim 1, further comprising the steps of washing with distilled water, drying and calcining the precipitate.

6. The process of claim 5, wherein the calcination is performed at 800° C. for 30 minutes.

7. The process of claim 1, wherein the reactor is run at room temperature.

8. A process for preparing a pearl pigment, comprising the steps of: (a) adding an aqueous solution of metal oxide to a substrate in a reactor; and (b) adding ammonium bicarbonate aqueous solution as a precipitating agent, wherein the metal oxide aqueous solution and the ammonium bicarbonate aqueous solution are introduced into the reactor through two different inlets.

9. (canceled)

10. The process of claim 8, wherein the inlets are placed in the opposite sides of the reactor.

11. The process of claim 8, wherein the substrate is selected from the group consisting of mica, a phyllosilicate, PbCO₃×Pb(OH)₂, BiOCl and platelet shaped SiO₂.

12. The process of claim 8, wherein the substrate is mica.

13. The process of claim 8, wherein the metal oxide is titanium oxide.

14. The process of claim 13, wherein the titanium oxide aqueous solution is prepared by using 9.6-28.8 w/v % of titanium salt relative to mica.

15. The process of claim 14, wherein the ammonium bicarbonate aqueous solution is prepared by using 1.5-10 moles of the ammonium bicarbonate relative to 1 mole of the titanium salt.

16. The process of claim 11, wherein when the titanium aqueous solution and the ammonium bicarbonate aqueous solution are introduced, the reactor is agitated at a speed of 3000-6500 rpm.

17. The process of claim 8, further comprising the step of calcining the substrate at 800° C. for 30 minutes.

18. The process of claim 8, wherein the reactor is run at room temperature.

19-20. (canceled)
